(19) United States
(12) Patent Application Publication
(10) Pub. No.: US 2026/0022307 A1
(43) Pub. Date: Jan. 22, 2026

(54) ADJUSTABLE WICK CENTERING DEVICE

(71) Applicant: Andrew-Phillip PARDIAC-FORGE, Montreal (CA)

(72) Inventor: Andrew-Phillip PARDIAC-FORGE, Montreal (CA)

(21) Appl. No.: 19/274,745

(22) Filed: Jul. 21, 2025

Related U.S. Application Data
(60) Provisional application No. 63/673,808, filed on Jul. 22, 2024.

(51) Int. Cl. C11C 5/00; C11C 5/02

(52) U.S. Cl. CPC C11C 5/006; C11C 5/023

(57) ABSTRACT

A wick centering device for supporting a wick inside a jar during the filling thereof with a wax mixture. The device includes first and second arm members generally parallel to one another, with each arm member having a longitudinal outer end for mounting on the jar and an opposite longitudinal inner end extending toward the longitudinal outer end of the other arm member. A wick supporting member movably connects to the arm members adjacent the respective longitudinal inner end and is positioned generally halfway between the longitudinal outer ends of the arm members. The wick supporting member includes a reciprocating mechanism allowing a simultaneous displacement of the respective longitudinal inner end of both arm members toward or away from the wick supporting member and relative to one another. The wick supporting member has a wick notch formed therein adapted to support the wick.

### CROSS-REFERENCE TO RELATED APPLICATIONS

The present application claims the benefit of U.S. provisional patent application No. 63/673,808, filed on Jul. 22, 2024.

### TECHNICAL FIELD OF THE INVENTION

The present disclosure relates to candles, and more specifically to a wick centering device used during the manufacturing of a candle, and that is preferably adjustable to different jar (or container) shapes and/or sizes.

### BACKGROUND OF THE INVENTION

Traditionally, in typical candle manufacturing, the wick needs to be supported in a generally vertical orientation typically at about the central axis of the jar into which the wax is to be poured, and further held in that position during setting of the wax. Although the wick typically comes into an already rectilinear rigid state, and often mounted on a small setter base, it is required to essentially hold it in place during the wax pouring and setting process. Most wick supports are simply manually placed on the top rim of the jar across the opening, and the positioning ensures that the wick is approximately centered within the jar.

Some other supports are tailored for a specific jar size and ensure that the wick is maintained at the center of the jar. But these wick centering supports often block a significant portion of the opening thus allowing wax to spill there over during the pouring process (and then requiring a cleaning thereof after its use). Because of their design, some wick centering devices are limited to specific jar sizes and shapes. Other devices have some grooves machined therein to adapt the devices to specific dimensions and/or sizes, and a mis-centering of the device on the jar often makes the typically metallic wick setter base being placed crooked as a result.

Also, some wick centering devices simply do not secure the wick on the jar, resulting in shifting or misalignment of the wick during the pouring and setting process, ultimately affecting the candle's performance such as uneven burning of the candle or the like.

Accordingly, there is a need for a wick centering device being adjustable to a plurality of jar sizes and/or shapes.

### SUMMARY OF THE INVENTION

It is therefore a general object of the present disclosure to provide a wick centering device that obviates the above-noted drawbacks and problems.

An advantage of the present invention is that the wick centering device can easily find the center of various jars (size and/or shape and/or opacity) and can stabilize the top part of a wick during the pouring and curing (setting) process.

Another advantage of the present invention is that the wick centering device can be easy to use and precise every time. The device may include a locking mechanism that allows user to set and retain the desired width for repeated use on same jars, even after storage,

A further advantage of the present invention is that the wick centering device can easily adapt to various shapes of the jar top opening, being circular, elliptical, polyhedral, or even diamond-like shape.

Another advantage of the present invention is that the wick centering device can, for practical reasons, be typically adjustable to a respective limited range of jar opening sizes.

Yet further advantages of the present invention are that the wick centering device can:
be light weight and/or durable;
be resistant up to typically about 100° C. (about 212° F.) or above;
typically have reversed V-shape feet to keep the device in place on various rim sizes and/or shapes. Other foot or connector shapes may use different angles or rounded edges to secure the device from either simple gravity, inward or outward pressure to secure itself to jar with two or more contact points with the jar per foot;
be designed to minimize the chances of accidentally having wax mixture being poured into the gears with a protective top and bottom cover of the central wick supporting member;
be easily cleaned-up in case of accidental spill of wax mixture thereon, such as by simply dip the device in hot water between about 80-100° C. to stir molten wax out of the device;
support more than one wick at the same time, using respective wick notches, and
provide close to 50% of the jar opening surface area free of parts of the device to allow for an easy pouring of the wax mixture into the jar.

Yet another advantage of the present invention is that the wick centering device, when in an up-side-down configuration, can be further used to support and align a centering target member at the bottom of the jar to properly position and center the wick setter base on the bottom wall of the jar, especially when the bottom wall is at least partially translucid. In this process, there may be a use of magnets in or on the tab setting device to hold the metal tab until the tab is affixed to the jar bottom in alignment with the centering target member which may also be magnetized to secure the tab in place throughout the candle curing process.

According to an aspect of the present disclosure there is provided a wick centering device for supporting a wick inside a jar during the filling thereof with a wax mixture, the device comprising:
first and second arm members generally parallel to one another, each said first and second arm members having a longitudinal outer end for mounting on the jar and an opposite longitudinal inner end extending toward the longitudinal outer end of the other one said first and second arm members; and
a wick supporting member movably connecting to the first and second arm members adjacent the respective longitudinal inner end and being positioned generally halfway between the longitudinal outer ends of the first and second arm members, the wick supporting member including a reciprocating mechanism allowing a simultaneous displacement of the respective longitudinal inner end of both said first and second arm members toward or away from the wick supporting member and relative to one another, the wick supporting member having a wick (receiving) notch formed therein adapted to support the wick.

In one embodiment, the longitudinal outer end of each said first and second arm members has a transverse arm for sitting on and being supported by a top edge (rim) of a side wall of the jar.

In one embodiment, each said transverse arm sitting on the jar top edge at two opposed contact feet, a respective positioning of each said contact feet on the jar top edge and an arrangement of the first and second arm members and the wick supporting member ensuring that the wick notch is adjacent a central vertical axis of the jar generally centrally positioned relative to a shape of a top wall opening defined by the top edge.

Conveniently, each one said contact feet being spaced from the wick notch by a respective distance, all said distances being equal to one another, i.e. all said contact feet essentially forming a support surface therebetween, the support surface having a center thereof generally in vertical alignment with the wick notch.

Conveniently, the first and second arm members and the reciprocating mechanism are all located on a side of the wick notch opposite the wick notch.

In one embodiment, the first and second arm members are longitudinally slidably mounted on the wick supporting member, the reciprocating mechanism including a rack mounted along each respective first and second arm members and a pinion freely rotatably mounted on the wick supporting member, the pinion mounting between the two racks and simultaneously operatively connecting (or meshing) therewith.

In one embodiment, each said contact foot has a reversed concave shape.

Conveniently, the reversed concave shape is a reversed V-shape.

Conveniently, each said contact foot lies into a respective plane generally parallel to an adjacent the central vertical axis.

In one embodiment, the longitudinal inner end of each said first and second arm members has a stop member for abutment with the wick supporting member.

In one embodiment, the device further includes a wick centering target member having a target marked thereon, the wick centering target member being supported by the wick supporting member to align a center of a target of the wick centering target member with the wick notch.

Other objects and advantages of the present invention will become apparent from a careful reading of the detailed description provided herein, with appropriate reference to the accompanying drawings.

### BRIEF DESCRIPTION OF THE DRAWINGS

Embodiments of the disclosure will be described by way of examples only with reference to the accompanying Figures, with similar references referring to similar components, in which:

FIG. 1 is a schematic and partially broken top perspective view of a wick centering device in accordance with an embodiment of the present invention, showing the device mounted on a jar for supporting and centering a wick therein;

FIG. 2 is a schematic and partially broken front view of the embodiment of FIG. 1;

FIG. 3 is a schematic top plan view of the embodiment of FIG. 1;

FIG. 4 is a schematic enlarged top plan view of the embodiment of FIG. 1, showing the internal reciprocating mechanism in transparency mode with stippled lines of the features of the housing that supports the reciprocating mechanism, as well as for the internal racks of the arm members;

FIG. 5 is a schematic exploded bottom perspective view of the embodiment of FIG. 1, showing the different parts of the wick supporting member with the reciprocating mechanism; and

FIG. 6 is a simplified schematic and partially broken bottom perspective view of the embodiment of FIG. 1, showing the use of the wick centering device in an up-side-down configuration at the bottom of the jar to support and align a wick centering target.

### DETAILED DESCRIPTION OF THE INVENTION

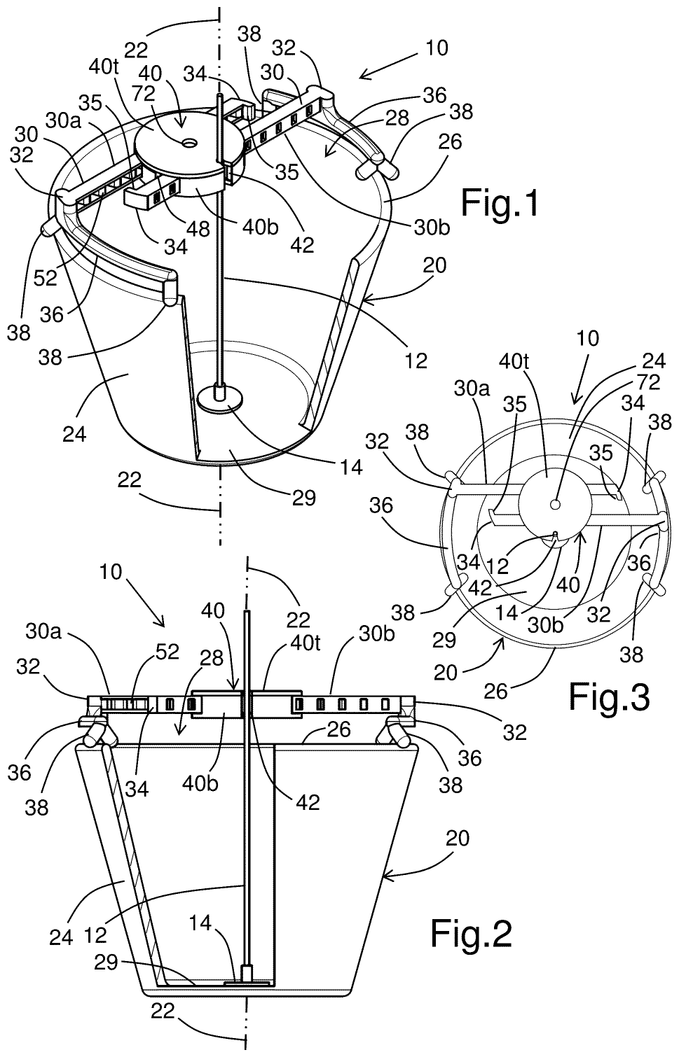

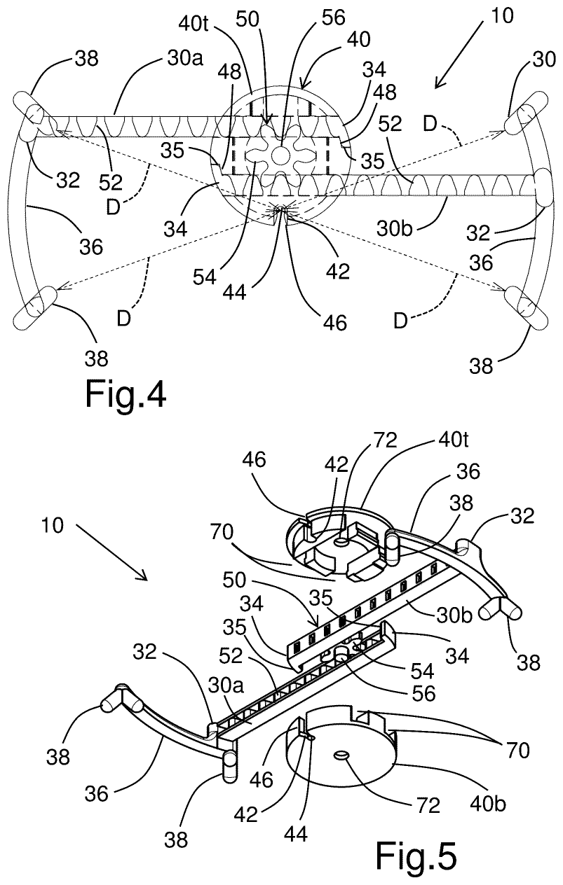

Referring to FIGS. 1 to 6, there is an embodiment of a wick centering device 10 in accordance with the present invention. The wick centering device 10 is adapted to support a wick 12 inside a jar 20 (or container), typically along a central vertical axis 22 of the jar 20, during the filling thereof with a wax mixture (not shown). The wick centering device 10 includes first 30a and second 30b arm members 30, generally parallel to one another, each having a longitudinal outer end 32 mounting on the jar 20 and an opposite longitudinal inner end 34, extending toward the longitudinal outer end 32 of the other arm member 30. The wick centering device 10 also includes and a wick supporting member 40 movably connecting to the first and second arm members 30 adjacent the respective longitudinal inner end 34. The wick supporting member 40 is positioned generally halfway between the longitudinal outer ends 32 of the first and second arm members 30, and includes a reciprocating mechanism 50 allowing a simultaneous displacement of the respective longitudinal inner end 34 of both said first and second arm members 30 toward or away from the wick supporting member 40 and relative to one another. The reciprocating mechanism 50, better seen in FIGS. 4 and 5, allows the two arms 30 to simultaneously slide in opposite directions relative to one another such that the longitudinal outer ends 32 essentially always remain at a same distance from the wick supporting member 40. The wick supporting member 40, typically formed of a housing with top section 40t and bottom section 40b typically releasably snapping to one another, has a wick (receiving) notch 42 formed therein adapted to support the wick 12, typically at the inner apex region 44 of the typically tapered notch 42.

Typically, the longitudinal outer end 32 of each arm member 30 has a transverse arm 36 (substantially perpendicular to the arm member 30) adapted to sit on and be supported by a top edge (or rim) 26 of a side wall 24 of the jar 20 that forms a top opening 28 of the jar 20. Each transverse arm 36 at has two longitudinally opposed contact feet 38 to sit on the jar top edge 26. The respective positioning of each contact foot 38 on the jar top edge 26, along with the arrangement of the first and second arm members 30 and the wick supporting member 40 ensure that the wick notch 42 is adjacent the central vertical axis 22 of the jar 20 and generally centrally positioned relative to the shape of the top wall opening 28.

As better seen in FIG. 4, each contact foot 38 is typically spaced from the wick notch 42 by a respective distance D (shown in stippled lines), with all said distances D being generally equal to one another, and with the first and second arm members 30 and the reciprocating mechanism 50 all being located on a same side of the wick notch 42, when seen in a plan view (see FIG. 4), opposite the side of the opening 46 of the wick notch 42.

Typically, each contact foot 38 has a reversed concave shape, and preferably a reversed V-shape so as to properly ensure that the device 10 is kept in place on the edge 26, which could be of various sizes and shapes. Although not illustrated in the figures, it would be obvious to one skilled in the art that any other shape of contact foot 38 could be considered, such as a reverse L-shape (with the horizontal portion lying generally radially on top of the top edge 26 and the vertical portion extending along the side wall 24 (inside or outside of the jar 20) downwardly toward the bottom of the jar 20) for example and the like, without departing from the scope of the present invention.

Also, each contact foot 38 lies into a respective foot plane that is generally parallel to an adjacent the central vertical axis 22 (one skilled in the art would readily understand that all the foot planes could intersect each other at the central vertical axis for only one specific size of the jar top opening 28).

As better seen in FIGS. 4 and 5, in order to adjust the mounting of the device 10 onto a wide variety of sizes and/or shapes of the jar top opening 28, the first and second arm members 30 are typically longitudinally slidably mounted on the wick supporting member 40. The housing 40 typically includes guiding slots 70 (or through-channels) formed therein to slidably receives the two arm members 30 therein, and a guiding through hole 72 perpendicular to the guiding slots 70 to freely rotatably receive a pinion shaft 56 therein.

The reciprocating mechanism 50, essentially allowing for the simultaneous sliding displacement of both arm members 30 away or toward the housing 40, in opposite directions relative to one another (to keep the housing 40 centered there between), typically includes a rack 52 mounted along each respective first and second arm members 30 and a pinion 54 freely rotatably mounted on the wick supporting member 40. The pinion (or gear) 54 typically mounts between the two racks 52 and simultaneously operatively connects (or meshes) therewith. Accordingly, when one of the arm members 30 is displaced in one direction relative to the wick supporting member 40, the other one of the two arm members 30 is automatically being displaced into the opposite direction relative to the wick supporting member 40, because of the pinion 54 being freely rotatably mounted on the wick supporting member 40.

Typically, to prevent the longitudinal inner end 34 of each arm member 30 to slip (slide) out from the wick supporting member 40, each longitudinal inner end 34 has an arm stop member 35, typically in the form of the transverse protrusion tab or the like, for abutment with the wick supporting member 40 that preferably includes a corresponding stopping edge 48, typically in the form of a step recess or the like, located on the bottom section 40b. Obviously, each transverse arm 36 similarly acts as a stopper to prevent the longitudinal outer end 32 from slipping (sliding) out from the wick supporting member 40.

As better seen in FIGS. 1-3, the wick 12 is typically made to be held into a jar 20 when the wax mixture is being poured therein and during the mixture setting. Typically, the wick 12 is already essentially rectilinear and rigid, and is mounted on a planar wick setter base 14 adapted to sit flat on the jar bottom wall 29.

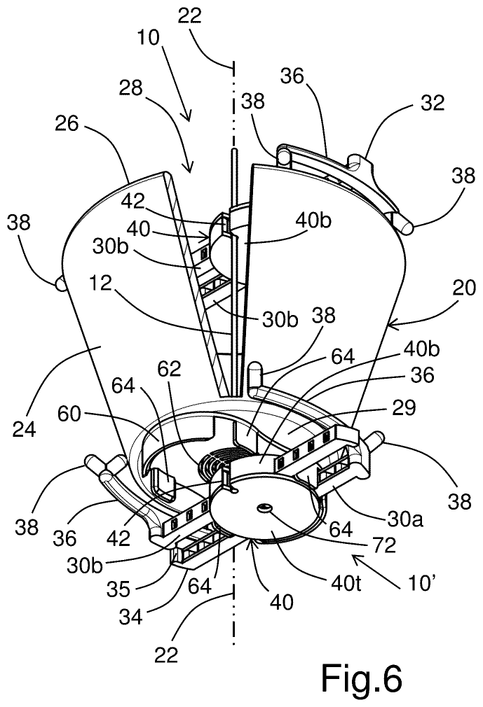

As illustrated in FIG. 6, in order to properly center the wick base 14 on the bottom wall 29, the device, preferably a second device 10′, can be used up-side-down adjacent the bottom wall 29, with the contact feet 38 positioned either in abutment against the side wall 24 (to essentially tightly embrace the lower portion of the side wall 24) or below a protruding lower edge (or rim-not shown) of the side wall 24, to support a wick centering target piece member 60 that allows the proper alignment and positioning of the wick base 14 on the bottom wall 29. The target member 60 typically sits on top of the up-side-down device 10′, above the wick supporting member 40, and is made to have the center of a target 62 aligning with the apex region 44 of the wick notch 42. The target member 60 typically includes guide tabs 64 extending therefrom to fit between the respective arm members 30 therein and therefore properly position the housing 40 therein, relative to the target 62. Obviously, the above-mentioned use of a target member 60 is only possible when the bottom wall 29 is at least partially translucid (not totally opaque). Optionally, the target member 60 is symmetrical about the target center to essentially fit the device 10′ on either side of the vertical axis 22, as illustrated by one pair of guide tabs 64 on each side of the vertical axis 22. The target member 60 typically allows for the jar 20 between both devices 10, 10′ to sit thereon, while being itself supported on a surface.

Although not specifically illustrated, the target member 60 could be secured to the jar 20 using magnets or the like to removably secure it in place while ensuring proper positioning or centering thereof. Similarly, a locking mechanism (not shown) or the like could be used to selectively lock the position of the first and second arm members 30 relative to the wick supporting member 40 to allow the user to set and retain the desired width for repeated use on same jars.

Although the present disclosure has been described with a certain degree of particularity and by way of an illustrative embodiment and examples thereof, it is to be understood that the present disclosure is not limited to the features of the embodiments described and illustrated herein, but includes all variations and modifications within the scope and spirit of the disclosure as hereinafter claimed.

1. A wick centering device for supporting a wick inside a jar during the filling thereof with a wax mixture, the device comprising:
first and second arm members generally parallel to one another, each said first and second arm members having a longitudinal outer end for mounting on the jar and an opposite longitudinal inner end extending toward the longitudinal outer end of the other one said first and second arm members; and
a wick supporting member movably connecting to the first and second arm members adjacent the respective longitudinal inner end and being positioned generally halfway between the longitudinal outer ends of the first and second arm members, the wick supporting member including a reciprocating mechanism allowing a simultaneous displacement of the respective longitudinal inner end of both said first and second arm members toward or away from the wick supporting member and relative to one another, the wick supporting member having a wick notch formed therein adapted to support the wick.

2. The device of claim 1, wherein the longitudinal outer end of each said first and second arm members has a transverse arm for sitting on and being supported by a top edge of a side wall of the jar.

3. The device of claim 2, wherein each said transverse arm sitting on the jar top edge at two opposed contact feet, a respective positioning of each said contact feet on the jar top edge and an arrangement of the first and second arm members and the wick supporting member ensuring that the wick notch is adjacent a central vertical axis of the jar generally centrally positioned relative to a shape of a top wall opening defined by the top edge.

4. The device of claim 3, wherein each one said contact feet being spaced from the wick notch by a respective distance, all said distances being equal to one another.

5. The device of claim 4, wherein the first and second arm members and the reciprocating mechanism are all located on a side of the wick notch opposite the wick notch.

6. The device of claim 1, wherein the first and second arm members are longitudinally slidably mounted on the wick supporting member, the reciprocating mechanism including a rack mounted along each respective first and second arm members and a pinion freely rotatably mounted on the wick supporting member, the pinion mounting between the two racks and simultaneously operatively connecting therewith.

7. The device of claim 1, further including a wick centering target member having a target marked thereon, the wick centering target member being supported by the wick supporting member to align a center of a target of the wick centering target member with the wick notch.
